(19) United States
(12) Patent Application Publication
(10) Pub. No.: US 2024/0198648 A1
(43) Pub. Date: Jun. 20, 2024

(54) LIQUID METAL SELF-ASSEMBLY FILM AND PREPARATION METHOD THEREFOR

(71) Applicant: SHENZHEN UNIVERSITY, Shenzhen (CN)

(72) Inventors: Xuechang ZHOU, Shenzhen (CN); Xiaolong YANG, Shenzhen (CN); Tiansheng GAN, Shenzhen (CN)

(73) Assignee: SHENZHEN UNIVERSITY, Shenzhen (CN)

(21) Appl. No.: 18/533,582

(22) Filed: Dec. 8, 2023

(30) Foreign Application Priority Data
Dec. 16, 2022 (CN) 202211622026.0

(51) Int. Cl. B32B 37/00; B32B 15/08; B32B 37/24

(52) U.S. Cl. CPC B32B 37/025; B32B 15/08; B32B 37/24; B32B 2307/7376; B32B 2310/028

(57) ABSTRACT

A liquid metal self-assembly film and a preparation method therefor, the method includes steps of providing a surfactant solution and a liquid metal, among them a solvent of the surfactant solution is an organic solvent, a density of the solvent of the surfactant solution is less than a density of water, the solvent of the surfactant solution is immiscible with water; adding the liquid metal into a quantity of water to obtain a liquid metal solution; adding the surfactant solution into the liquid metal solution for an ultrasonic mixing to obtain a liquid metal self-assembly seed solution; mixing the liquid metal self-assembly seed solution and a quantity of water to obtain a mixture, among them a lower layer of the mixture is a water phase, and an upper layer of the mixture is an oil phase; and obtaining the liquid metal self-assembly film at oil-water interface.

### CROSS-REFERENCES TO RELATED APPLICATIONS

This application claims priority to Chinese Patent Application No. 202211622026.0, filed on Dec. 16, 2022, the content of all of which is incorporated herein by reference.

### FIELD

The present disclosure relates to the technical field of liquid metal films, in particular to a liquid metal self-assembly film and a preparation method therefor.

### BACKGROUND

Liquid metal (generally referring to gallium and its alloy) possesses both fluidic and metallic properties, exhibiting high electrical conductivity, high thermal conductivity, and good biocompatibility. The liquid metal finds broad applications in fields such as wearable and flexible electronics, catalysis, and biomedicine. The existing preparation methods for liquid metal film mainly include molding method, printing method, and thermal evaporation method (such as those disclosed in Chinese patents CN106498348A and CN112662999A). Among them, the thermal evaporation method involves using liquid metal as an evaporation source, thermally evaporating the liquid metal once or multiple times in a thermal evaporation equipment, and evaporating and depositing liquid metal particles on a surface of a flexible substrate. Although the thermal evaporation method shows a certain improvement in process complexity and equipment requirements compared with the molding method and the printing method, in general, these methods still face challenges such as the need for relatively expensive and complicated equipment, relatively complicated preparation process, and low preparation efficiency. It is of great significance to provide a method with simpler process, lower cost and higher preparation efficiency for the widespread application of liquid metal films.

Therefore, the prior art still needs to be improved and developed.

### SUMMARY

In view of the above-mentioned deficiencies of the prior art, an object of the present disclosure is to provide a liquid metal self-assembly film and a preparation method therefor, aiming to solve the problems of the existing preparation method for liquid metal film that the process is relatively complicated, expensive equipment is required, and the preparation efficiency is low.

Technical schemes of the present disclosure are as follows.

In a first aspect of the present disclosure, a preparation method for a liquid metal self-assembly film is provided, which includes steps of:
providing a surfactant solution and a liquid metal, and a solvent of the surfactant solution is an organic solvent, a density of the organic solvent is less than a density of water, the organic solvent is immiscible with water;
adding the liquid metal into a quantity of water to obtain a liquid metal solution;
adding the surfactant solution into the liquid metal solution for an ultrasonic mixing to obtain a liquid metal self-assembly seed solution;
mixing the liquid metal self-assembly seed solution and a quantity of water to obtain a mixture, and a lower layer of the mixture is a water phase, and an upper layer of the mixture is an oil phase; and obtaining the liquid metal self-assembly film at an oil-water interface.

In some embodiments, the organic solvent is selected from the group consisting of methyl methacrylate, toluene, and n-hexane;
and/or, a surfactant in the surfactant solution is a surfactant containing a single carboxyl group, the surfactant containing the single carboxyl group is selected from the group consisting of acetic acid, propionic acid, butyric acid, valeric acid, hexanoic acid, heptanoic acid, octanoic acid, nonanoic acid, decanoic acids, hendecanoic acid, lauric acid, tridecanoic acid, myristic acid, isocetic acid, palmitic acid, margaric acid, stearic acid, nonadecanoic acid, arachidic acid, hexenoic acid, crotonic acid, pentenoic acid, hexenoic acid, heptenoic acid, octenoic acid, nonenoic acid, decenoic acid, undecenoic acid, dodecenoic acid, tridecenoic acid, tetradecenoic acid, pentadecenoic acid, hexadecenoic acid, heptadecenoic acid, octadecenoic acid, nonadecyenoic acid, and eicosenoic acid;
and/or, the liquid metal is selected from the group consisting of gallium indium tin alloy, and eutectic gallium indium.

In some embodiments, a concentration of a surfactant in the surfactant solution is 0.5-9 mmol/L;
and/or, a concentration of the liquid metal in the liquid metal solution is 10-400 mg/mL.

In some embodiments, a volume ratio of the surfactant solution to the liquid metal solution is (1-5):(9-5).

In some embodiments, a duration of the ultrasonic mixing is 10-120 minutes, and a temperature of the ultrasonic mixing is 0-1° C.

In some embodiments, in the step of mixing the liquid metal self-assembly seed solution and the quantity of water to obtain the mixture, a volume ratio of the liquid metal self-assembly seed solution to the quantity of water is 10:(20˜100).

In some embodiments, the method further includes steps of:
providing a first substrate;
inserting the first substrate from the oil phase vertically into the water phase of the lower layer, tilting upwards and lifting one end of the first substrate inserted into the water phase until the end leaves an upper surface of the oil phase, transferring the liquid metal self-assembly film at the oil-water interface to the first substrate, and obtaining the liquid metal self-assembly film on the first substrate.

In some embodiments, the method further includes steps of:
providing a flexible second substrate having a preset pattern, inserting the flexible second substrate from the oil phase vertically into the water phase of the lower layer, tilting upwards and lifting one end of the flexible second substrate inserted into the water phase until the end leaves an upper surface of the oil phase, transferring the liquid metal self-assembly film at the oil-water interface to the flexible second substrate, forming a patterned liquid metal self-assembly film on the flexible second substrate, spraying ethanol on the patterned liquid metal self-assembly film;
providing a metal transfer substrate;
heating the metal transfer substrate, arranging the flexible second substrate containing the patterned liquid metal self-assembly film on the heated metal transfer substrate, and the patterned liquid metal self-assembly film is attached to the metal transfer substrate;
vertically pressing one side of the flexible second substrate deviating from the metal transfer substrate, transferring the patterned liquid metal self-assembly film onto the metal transfer substrate, and obtaining the patterned liquid metal self-assembly film on the metal transfer substrate.

In a second aspect of the present disclosure, a liquid metal self-assembly film is provided, and the liquid metal self-assembly film is prepared by the above-mentioned methods.

In some embodiments, a thickness of the liquid metal self-assembly film is 300-1000 nm.

Beneficial effects: the present disclosure provides a simple from-bottom-to-top self-assembly method, using ultrasonic technology to graft a surfactant on a surface of a liquid metal nanoparticle to obtain a liquid metal nanoparticle with surface-modified surfactant. After a metal self-assembly seed solution containing the liquid metal nanoparticle with surface-modified surfactant is mixed with water, a lower layer is a water phase, and an upper layer is an oil phase. At an oil-water-liquid-liquid interface, the liquid metal nanoparticles with surface-modified surfactant attract each other through a non-covalent interaction force, and can quickly form a dense film structure within a few seconds, achieving a quick self-assembly preparation for the liquid metal film. At the same time, the non-covalent interaction force between the liquid metal nano-droplets with surface-modified surfactant further improves a stability of the film. The preparation method provided by the present disclosure has the advantages of simple process, fast preparation speed, high efficiency and no need of expensive equipment.

### BRIEF DESCRIPTION OF THE DRAWINGS

FIG. 1 is a schematic diagram of inserting a first substrate from an oil phase vertically into a water phase below the oil phase, and then titling upwards and lifting one end of the first substrate inserted into the water phase to an upper surface of the oil phase, and transferring a liquid metal self-assembly film at an oil-water interface to the first substrate in an embodiment of the present disclosure.

FIG. 2 (a) is a schematic diagram of providing a metal transfer substrate and a flexible second substrate, wherein a surface of the flexible second substrate contains a patterned liquid metal self-assembly film; FIG. 2 (b) is a schematic diagram of arranging the flexible second substrate containing the patterned liquid metal self-assembly film on the metal transfer substrate to make the patterned liquid metal self-assembly film attached to the metal transfer substrate, and vertically pressing one side of the flexible second substrate deviating from the metal transfer substrate; FIG. 2 (c) is a schematic diagram of completing transferring the patterned liquid metal self-assembly film from the flexible second substrate to the metal transfer substrate.

FIG. 3 is a schematic diagram of a laser confocal Raman spectra of a hexanoic acid-modified liquid metal self-assembly film prepared in embodiment 1 and an octadecenoic acid-modified liquid metal self-assembly film prepared in embodiment 2 of the present disclosure.

FIG. 4 is a 50,000-fold scanning electron microscope (SEM) image of capturing an octadecenoic acid-modified liquid metal self-assembly film by a high-resolution scanning electron microscope after the octadecenoic acid-modified liquid metal self-assembly film prepared in embodiment 2 of the present disclosure is taken out by a glass slide.

FIG. 5 is a schematic diagram of a result of a self-healing property test of an octadecenoic acid-modified liquid metal self-assembly film prepared by mixing a liquid metal self-assembly seed solution in embodiment 2 with ultrapure water with a volume ratio of 1:9; among them, (a) is a picture result of the film taken out at a first time; (b) is a picture result of the film self-healing at a first time; (c) is a picture result of the film taken out at a third time; (d) is a picture result of the film self-healing at a third time.

FIG. 6 is a schematic diagram of a result of transferring a liquid metal self-assembly film in embodiment 3 to a copper substrate after the liquid metal self-assembly film on a flexible patterned polydimethylsiloxane (PDMS) substrate is taken out.

### DETAILED DESCRIPTION OF EMBODIMENTS

The present disclosure provides a liquid metal self-assembly film and a preparation method therefor. In order to make the purposes, technical schemes and advantages of the present disclosure clearer and more explicit, the following is a further detailed description of the present disclosure. It should be understood that the specific embodiments described here are only used to explain the present disclosure, not to limit the present disclosure.

Unless otherwise defined, all technical and scientific terms used herein have the same meaning as commonly understood by those ordinary skilled in the technical field of the present disclosure. The terms used herein in the description of the present disclosure are only for the purpose of describing specific embodiments, and are not intended to limit the present disclosure.

An embodiment of the present disclosure provides a method for preparing a liquid metal self-assembly film, which includes following steps of:
S10, providing a surfactant solution and a liquid metal, among them, a solvent of the surfactant solution is an organic solvent, a density of the organic solvent is less than a density of water, and the organic solvent is immiscible with water;
S20, adding the liquid metal into a quantity of water to obtain a liquid metal solution;
S30, adding the surfactant solution into the liquid metal solution; and ultrasonically mixing the surfactant solution and the liquid metal solution to obtain a liquid metal self-assembly seed solution;
S40, mixing the liquid metal self-assembly seed solution and a quantity of water to obtain a mixture, among them, a lower layer of the mixture is a water phase, and an upper layer of the mixture is an oil phase; and obtaining the liquid metal self-assembly film at an oil-water interface.

Different from traditional from-top-to-bottom photolithography and printing, the present embodiment of the present disclosure provides a simple from-bottom-to-top self-assembly method, that is, liquid-liquid interface self-assembly. Liquid metal nanoparticles (also known as liquid metal nano-droplets) have a high degree of fluidity at an oil-water-liquid-liquid interface, which can achieve rapid equilibrium assembly. At the same time, the high degree of fluidity can further achieve a self-correction of a defect of the liquid metal self-assembly film, making the liquid metal self-assembly film have self-healing property.

In the present embodiment of the present disclosure, ultrasonic technology is firstly used to add a surfactant solution into a liquid metal solution for ultrasonic mixing, and the surfactant is grafted on a surface of the liquid metal nanoparticle to obtain a liquid metal nanoparticle with surface-modified surfactant. Then, after a liquid metal self-assembly seed solution containing the liquid metal nanoparticle with surface-modified surfactant is mixed with a quantity of water, the mixed solution is rapidly stratified, organic solvent is an oil phase in an upper layer of the mixed solution, and water is a water phase in a lower layer of the mixed solution. At an oil-water-liquid-liquid interface, the liquid metal nanoparticles with surface-modified surfactant attract each other by a non-covalent interaction force between the surfactants, and can quickly form a dense film structure within a few seconds, achieving a rapid self-assembly preparation for liquid metal film. At the same time, the non-covalent interaction force between the liquid metal nano-droplets with surface-modified surfactant also improves a stability of the film. The preparation method provided by the present disclosure has the advantages of simple process, fast preparation speed, high efficiency, no need of expensive equipment, and is favorable for popularization in industrialized production.

In the present embodiment, a liquid metal nanoparticle with high colloidal stability and uniform dispersion can be obtained by modifying a surface of a liquid metal nanoparticle, and a liquid metal nanoparticle with controllable size can be formed. In some embodiments, a particle size of liquid metal nanoparticle is 50-300 nm.

In the present embodiment, the steps of adding the liquid metal into the quantity of water to obtain the liquid metal solution, and then adding the surfactant solution into the liquid metal solution for ultrasonic mixing are due to that, in one aspect, if the surfactant solution is directly added to the liquid meta for ultrasonic, it makes the amount of the surfactant grafting on the surface of the liquid metal too high, and the too high amount of the surfactant grafting on the surface of the liquid metal makes it difficult to form subsequent self-assembly; in another aspect, the liquid metal in the oil phase (in the organic solvent) is not a stable system, causing a large amount of the liquid metal to agglomerate and precipitate during the ultrasonic process, so the liquid metal needs to be added to the quantity of water to form a liquid metal solution, and then the liquid metal solution is ultrasonically mixed with the surfactant solution.

In the step S10, in one embodiment, the organic solvent is selected from at least one of methyl methacrylate, toluene, and n-hexane, but is not limited thereto. The organic solvent is immiscible with water and have a lower density than water. As an oil phase, the organic solvent dissolves the surfactant and further reduces a surface energy of the liquid metal nanoparticle, making self-assembly easier.

In one embodiment, the liquid metal is selected from gallium-based liquid metals. The gallium-based liquid metal is selected from one of gallium indium tin alloy, and eutectic gallium indium, but not limited thereto. A melting point of the gallium-based liquid metal is close to room temperature, and the gallium-based liquid metal has both metal property and liquid property at the same time, and can spontaneously form a thin oxide layer at the interface, that is, a gallium oxide layer. The presence of the oxide layer allows the liquid metal to form a complex stable structure and tunable reactivity. The presence of the oxide layer further reduces a high surface tension of the liquid metal and improves a wettability of the liquid metal.

In one embodiment, the surfactant is selected from surfactants containing a single carboxyl group. In the present embodiment, the carboxyl group can be combined with the oxide layer on the surface of the liquid metal nanoparticle to achieve the grafting of the surfactant to the liquid metal nanoparticle.

In one embodiment, the surfactant containing a single carboxyl group is at least one selected from acetic acid, propionic acid, butyric acid, valeric acid, hexanoic acid, heptanoic acid, octanoic acid, nonanoic acid, decanoic acids, hendecanoic acid, lauric acid, tridecanoic acid, myristic acid, isocetic acid, palmitic acid, margaric acid, stearic acid, nonadecanoic acid, arachidic acid, hexenoic acid, crotonic acid, pentenoic acid, hexenoic acid, heptenoic acid, octenoic acid, nonenoic acid, decenoic acid, undecenoic acid, dodecenoic acid, tridecenoic acid, tetradecenoic acid, pentadecenoic acid, hexadecenoic acid, heptadecenoic acid, octadecenoic acid, nonadecyenoic acid, or eicosenoic acid, but not limited thereto. The surfactant containing a single carboxyl group can use the carboxyl group to combine with the oxide layer on the surface of the liquid metal nanoparticle to achieve the grafting of the surfactant to the liquid metal nanoparticle.

In one embodiment, in the surfactant solution, a concentration of the surfactant is 0.5-9 mmol/L, such as 0.5 mmol/L, 1 mmol/L, 2 mmol/L, 3 mmol/L, 4 mmol/L, 5 mmol/L, 6 mmol/L, 7 mmol/L, 8 mmol/L, or 9 mmol/L, etc. The surfactant of the concentration is more conducive to the self-assembly of the liquid metal into a dense film. When the concentration of the surfactant is lower than 0.5 mmol/L, it is not conducive to form film. When the concentration of the surfactant is higher than 9 mmol/L, it is easy to form a large chunk of agglomerate, which is not conducive to form dense liquid metal self-assembly film.

In the step S20, in one embodiment, the liquid metal is added into a quantity of ultrapure water; and the liquid metal solution is obtained after mixing the liquid metal and the quantity of ultrapure water. In a further embodiment, the mixing is ultrasonic mixing.

In one embodiment, in the liquid metal solution, a concentration of the liquid metal is 10-400 mg/mL, such as 10 mg/L, 30 mg/L, 50 mg/mL, 100 mg/L, 200 mg/L, 300 mg/L, or 400 mg/L, etc. The concentration of the liquid metal is more conducive to the self-assembly of the liquid metal into a dense film. When the concentration of the liquid metal is lower than 10 mg/L, it is not conducive to form film. When the concentration of the liquid metal is higher than 400 mg/L, it is easy to form a large chunk of agglomerate, which is not conducive to form dense liquid metal self-assembly film.

In the step S30, in one embodiment, a volume ratio of the surfactant solution to the liquid metal solution is (1-5):(9-5). The volume ratio can make the liquid metal self-assembly film more dense.

In one embodiment, a duration of the ultrasonic mixing is 10 to 120 min (for example, it may be 10 min, 20 min, 30 min, 50 min, 80 min, 100 min, or 120 min), and a temperature of the ultrasonic mixing is 0 to 1° C. (for example, it may be 0° C., 0.5° C., or 1° C., etc.). At a low temperature of 0-1° C., the grafting of the surfactant to the liquid metal particle is more stable. If the temperature is too high, the oxide layer on the surface of the liquid metal nanoparticle and the grafting are destroyed, making it easier for the liquid metal nanoparticles to agglomerate, causing the grafting and the self-assembly cannot be carried out. The present disclosure grafts the surfactant on the surface of the oxide layer of the liquid metal nanoparticle through an ultrasonic method, and the ultrasonic duration can make the grafting more sufficient. When the ultrasonic mixing duration is less than 10 min, the grafting of the surfactant to the liquid metal nanoparticle is insufficient, leading to waste. When the ultrasonic mixing duration is more than 120 min, local high temperature is caused by ultrasound, which affects the oxide layer of liquid metal nanoparticle and leads to agglomeration of the liquid metal, which is not conducive to the grafting.

Of course, in the step S20 and the step S30, the liquid metal may also be added into the quantity of water, and then the surfactant solution is added and ultrasonically mixed to obtain the liquid metal self-assembly seed solution.

In the step S40, in one embodiment, in the step of mixing the liquid metal self-assembly seed solution and the quantity of water, a volume ratio of the liquid metal self-assembly seed solution to the quantity of water is 10:(20˜100). The volume ratio can ensure that the liquid metal self-assembled film is denser.

In one embodiment, in the oil-water-liquid-liquid interface, a volume of the liquid metal self-assembly film in the water phase is about 20%, and a volume of the liquid metal self-assembly film in the oil phase is about 80%.

In one embodiment, the quantity of water is ultrapure water.

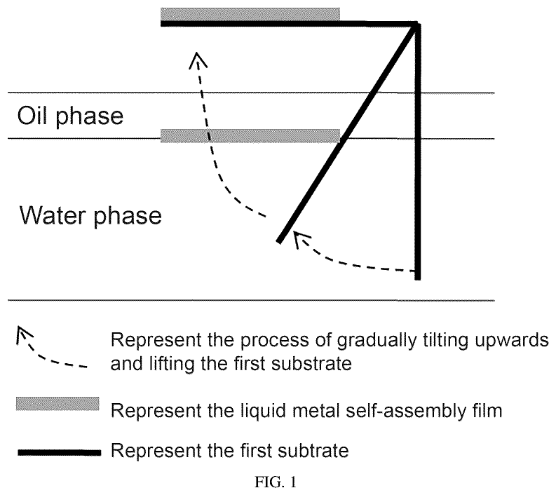

In one embodiment, the method for preparing the liquid metal self-assembly film further includes following steps of:
S511, providing a first substrate;
S512, as shown in FIG. 1, inserting the first substrate from the oil phase vertically into the lower water phase; and then tilting upwards and lifting one end of the first substrate inserted into the water phase until the end leaves an upper surface of the oil phase; transferring the liquid metal self-assembly film at the oil-water interface to the first substrate (that is, the film is taken out by a vertical-tilted method); and preparing and obtaining the liquid metal self-assembly film on the first substrate.

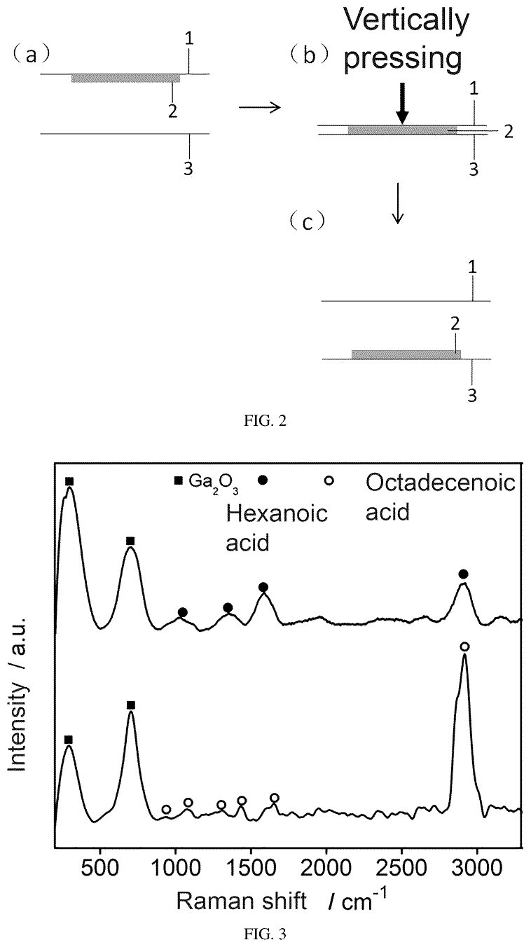

In the present embodiment, the first substrate includes a hydrophobic substrate and a hydrophilic substrate, the hydrophobic substrate includes but is not limited to hydrophobic glass, oil paper, etc., and the hydrophobic substrate also includes polydimethylsiloxane (PDMS), thermoplastic copolyester (Ecoflex), and other flexible substrates; the hydrophilic substrate includes but not limited to hydrophilic glass, metal substrate (such as copper substrate), etc. In one embodiment, the method for preparing the liquid metal self-assembly film further includes following steps of:
S521, providing a flexible second substrate with a preset pattern;
S522, inserting the flexible second substrate from the oil phase vertically into the lower water phase; and then tilting upwards and lifting one end of the flexible second substrate inserted into the water phase until the end leaves an upper surface of the oil phase; and transferring the liquid metal self-assembly film at the oil-water interface to the flexible second substrate; forming a patterned liquid metal self-assembly film on the flexible second substrate; and then spraying ethanol on the patterned liquid metal self-assembly film;
S523, as shown in FIG. 2(a), providing a metal transfer substrate 3 and the flexible second substrate 1 obtained in the step S522, among them, a surface of the flexible second substrate 1 contains the patterned liquid metal self-assembly film 2;
S524, heating the metal transfer substrate 3, as shown in FIG. 2(b); and arranging the flexible second substrate containing the patterned liquid metal self-assembly film on the heated metal transfer substrate, among them, the patterned liquid metal self-assembly film is attached to the metal transfer substrate;
S525, as shown in FIG. 2(b), vertically pressing one side of the flexible second substrate 1 deviating from the metal transfer substrate 3; as shown in FIG. 2(c), transferring the patterned liquid metal self-assembly film 2 onto the metal transfer substrate 3; and preparing and obtaining the patterned liquid metal self-assembly film 2 on the metal transfer substrate 3.

In the present embodiment, since ethanol has a lower surface tension, when the ethanol is sprayed on the patterned liquid metal self-assembly film, the ethanol can bridge the liquid metal self-assembly film at an interface of the liquid metal self-assembly film and the flexible second substrate, reducing the van der Waals force (also known as attraction force) between the patterned liquid metal self-assembly film and the flexible second substrate. By heating the metal transfer substrate, and by pressing vertically to apply force, the patterned liquid metal self-assembly film is in full contact with the heated metal transfer substrate, further reducing the van der Waals force between the patterned liquid metal self-assembly film and the flexible second substrate, thereby increasing the van der Waals attraction force between the metal transfer substrate and the patterned liquid metal self-assembly film to transfer the patterned liquid metal self-assembly film onto the metal transfer substrate.

In one embodiment, the flexible second substrate may be selected from flexible substrates such as PDMS or Ecoflex; the metal transfer substrate may be selected from copper substrates.

An embodiment of the present disclosure further provides a liquid metal self-assembly film, which is prepared by the above-mentioned preparation methods in the embodiments of the present disclosure.

In one embodiment, the liquid metal self-assembly film has a thickness of 300-1000 nm (for example, 300 nm, 400 nm, 500 nm, 600 nm, 700 nm, 800 nm, 900 nm, or 1000 nm). The liquid metal self-assembly film contains 0.6-0.9 wt % surfactant, and has high modulus (up to 690 GPa), strong wettability, and self-healing ability.

An embodiment of the present disclosure further provides an application of the liquid metal self-assembly film in the field of flexible electronics. In some embodiments, the liquid metal self-assembly film and a surface of a flexible material can be sintered to form a stretchable electronic wire path for application.

An embodiment of the present disclosure further provides an application of the liquid metal self-assembly film in the field of heat-conducting materials. In some embodiments, the liquid metal self-assembly film may be combined with an elastomer to form a large-area coherent adhesive heat-conducting material for application.

An embodiment of the disclosure further provides an application of the liquid metal self-assembly film in the field of batteries. In some embodiments, the liquid metal self-assembly film may be coated on a surface of a garnet to improve an adhesion of lithium, thereby improving battery performance.

The following is described in detail through some specific embodiments.

In the following embodiments, the SEM adopted is from Thermo Fisher Scientific, and the model of the SEM is APREO S.

### Embodiment 1

Adding 11.6 mg of hexanoic acid to 20 mL of methyl methacrylate, whirling for 5 minutes to obtain a hexanoic acid solution of 5 mmol/L, and storing the hexanoic acid solution in a refrigerator avoiding light;
Weighing and adding 300 mg of liquid metal (gallium indium tin alloy) into 9 mL of ultrapure water, then adding 1 mL of the hexanoic acid solution, and performing an ultrasonic treatment for 30 minutes at 0° C. to obtain a liquid metal self-assembly seed solution;
Arranging 20 mL of ultrapure water in a circular glass dish with a diameter of 9 cm, mixing 10 mL of the liquid metal self-assembly seed solution with the ultrapure water in the glass dish, and shaking for 5 seconds to obtain a liquid metal self-assembly film with hexanoic acid modified at the oil-water-liquid-liquid interface.

### Embodiment 2

Adding 28.2 mg of octadecenoic acid to 20 mL of methyl methacrylate, whirling for 5 minutes to obtain an octadecenoic acid solution of 5 mmol/L, and storing the octadecenoic acid solution in a refrigerator avoiding light;
Weighing and adding 300 mg of liquid metal (gallium indium tin alloy) into 9 mL of ultrapure water, then adding 1 mL of the octadecenoic acid solution, and performing an ultrasonic treatment for 30 minutes at 0° C. to obtain a liquid metal self-assembly seed solution;
Arranging 20 mL of ultrapure water in a circular glass dish with a diameter of 9 cm, mixing 10 mL of the liquid metal self-assembly seed solution with the ultrapure water in the glass dish, and shaking for 5 seconds to obtain a liquid metal self-assembly film with octadecenoic acid modified at the oil-water-liquid-liquid interface.

### Test:

(1) Laser confocal Raman spectra of the two liquid metal self-assembly films prepared in embodiments 1 and 2 are shown in FIG. 3. An upper spectral line in FIG. 3 is the laser confocal Raman spectrum of the hexanoic acid-modified liquid metal self-assembly film prepared in embodiment 1, and a lower spectral line in FIG. 3 is the laser confocal Raman spectrum of the octadecenoic acid-modified liquid metal self-assembly film prepared in embodiment 2. Comparing the two spectral lines, it can be seen that the characteristic peak of Ga₂O₃ is the characteristic peak of the oxide layer of the gallium indium tin alloy, and the peak positions and peak areas of the remaining characteristic peaks have obvious changes, indicating that the two surfactants both can be well grafted with liquid metal nanoparticle, and the liquid metal self-assembly films modified by different surfactants have different Raman spectra, so that in this way, different liquid metal self-assembly films can be further distinguished. In addition, at 2912.6 cm⁻¹, the Raman peak intensity of the octadecenoic acid-modified liquid metal self-assembly film is stronger than the Raman peak intensity of the hexanoic acid-modified liquid metal self-assembly film, indicating that the liquid metal self-assembly film with surface-modified surfactant has stronger Raman peak intensity at 2912.6 cm⁻¹ when modified with a surfactant having a longer alkane chain.

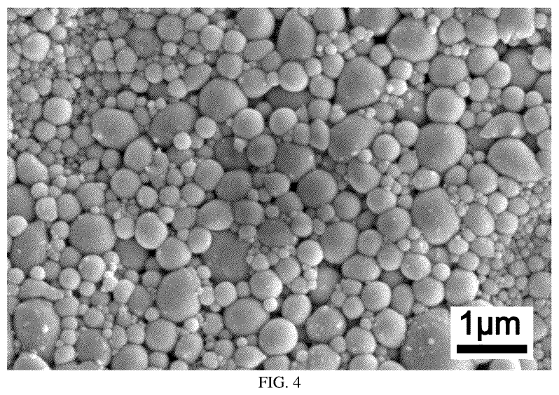

(2) After the octadecenoic acid-modified liquid metal self-assembly film prepared in embodiment 2 is taken out by a glass slide, a 50,000-fold SEM image taken with a high-resolution scanning electron microscope is shown in FIG. 4. It can be seen from FIG. 4 that the surface of the octadecenoic acid-modified liquid metal self-assembly film is dense and flat, without defects such as large cracks and holes, indicating that the interaction between the surfactants grafted on the surface of the liquid metal nanoparticle makes the film dense and stable, and the advantages from the liquid-liquid interface self-assembly further make the liquid metal self-assembly film flatter.

(3) The self-healing property of the octadecenoic acid-modified liquid metal self-assembly film is tested below:
Mixing the liquid metal self-assembly seed solution in embodiment 2 with ultrapure water at a volume ratio of 1:9, then shaking for 5 seconds, and obtaining the liquid metal self-assembly film at the oil-water-liquid-liquid interface;
Washing a 18×18 mm glass slide with ethanol under ultrasonic wave for 20 minutes, then drying the washed glass slide in an oven for 10 minutes, and using the dried glass slide to take out a liquid metal self-assembly film at one same position, among them, the liquid metal self-assembly film is obtained in the above step by the vertical-tilted film-taking out method (see above for details);
After multiple times of taking out the liquid metal self-assembly film at the same position, the octadecenoic acid-modified liquid metal self-assembly film at the oil-water-liquid-liquid interface completes a healing of a defect within 20 seconds.

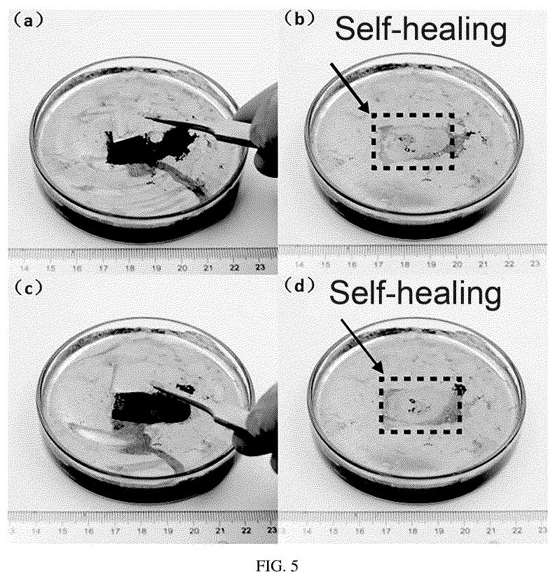

FIG. 5 is a result of a self-healing property test of the octadecenoic acid-modified liquid metal self-assembly film prepared by mixing the liquid metal self-assembly seed solution in embodiment 2 and ultrapure water with a volume ratio of 1:9, showing a self-healing behavior of the above-mentioned octadecenoic acid-modified liquid metal self-assembly film which is taken out multiple times at the same position by a glass slide. Among them, (a) is a picture result of the film which is taken out at a first time; (b) is a picture result of the film self-healing at a first time; (c) is a picture result of the film which is taken out at a third time; (d) is a picture result of the film self-healing at a third time. It can be seen from FIG. 5 that the octadecenoic acid-modified liquid metal self-assembly film has a rapid self-healing behavior at a defect, which is similar to human wound healing, that is, healing from an edge of the defect to a middle, and no external force is required during the process.

### Embodiment 3

The present embodiment is used to illustrate that the liquid metal self-assembly film obtained by the method of the present disclosure can be transferred to different substrates.

Mixing Sylgard 184 silicon base, and Sylgard curing agent at a mass ratio of 10:1, stirring with a stirrer for 3 minutes, mixing evenly, then vacuumizing for 30 minutes for a defoaming treatment, spin-coating on a patterned mold, and then performing a solidification treatment to obtain a flexible patterned PDMS substrate.

Mixing Ecoflex 00-30PART A and PART B at a mass ratio of 1:1, stirring with a stirrer for 3 minutes, mixing evenly, then vacuumizing for 30 minutes for a defoaming treatment, spin-coating on the patterned mold and, and then performing a solidification treatment to obtain a flexible patterned Ecoflex base.

Cutting both the flexible patterned PDMS substrate and the flexible patterned Ecoflex substrate into a square of 5×5 cm, and then taking out the liquid metal self-assembly film obtained at the oil-water-liquid-liquid interface in embodiment 1 by the vertical-tilted film-taking out method (see above for details), among them, the liquid metal self-assembly film is completely wet on patterned surfaces of the two flexible substrates.

It can be illustrated from embodiment 3 that the liquid metal self-assembly film prepared by the present disclosure can be transferred to different substrates.

### Embodiment 4

For different substrates, the liquid metal self-assembly film has different wettability, and a pattern of a flexible substrate can be transferred to any substrate by changing the wetting of the liquid metal self-assembly film to the flexible substrate.

After drying the liquid metal self-assembly film which is on the flexible patterned PDMS substrate after taken out in embodiment 3, an appropriate amount of absolute ethanol alcohol is sprayed on a surface of the liquid metal self-assembly film, thereby reducing the van der Waals force between the liquid metal self-assembly film and the flexible patterned PDMS substrate.

Heating a copper substrate (to increase an attraction force between the copper substrate and the liquid metal self-assembly film), and by the pressing vertically to apply surface force method, making the pattern of the flexible patterned PDMS substrate fully contact with the copper substrate for 3 minutes (that is, the flexible patterned PDMS substrate containing the liquid metal self-assembly film is stacked on the copper transfer substrate, among them, the liquid metal self-assembly film is attached to the copper transfer substrate, and then one side of the flexible patterned PDMS substrate deviating from the copper substrate is vertically pressed to make the pattern of the flexible patterned PDMS substrate in full contact with the copper transfer substrate, and the contact is maintained for 3 minutes), and obtaining the copper substrate printed with the liquid metal self-assembly film pattern.

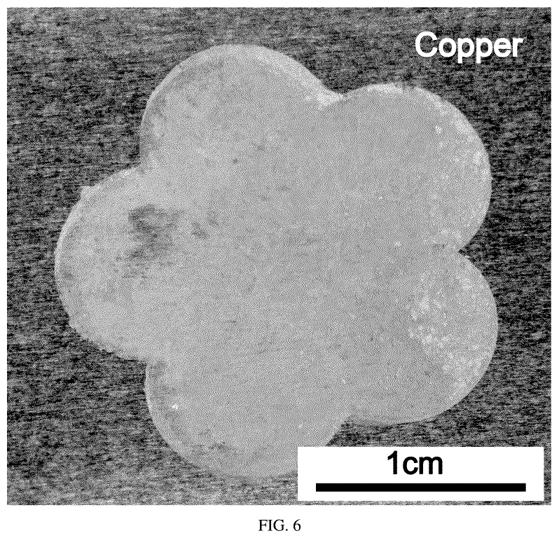

FIG. 6 is a schematic diagram of a result of transferring a liquid metal self-assembly film on a flexible patterned polydimethylsiloxane (PDMS) substrate after taken out in embodiment 3 to a copper substrate. It can be seen from FIG. 6 that the liquid metal self-assembly film on the flexible patterned PDMS substrate can be effectively transferred to the copper substrate.

In the present embodiment, by spraying the absolute ethanol alcohol and heating the copper substrate, an attraction force of the flexible patterned PDMS substrate to the liquid metal self-assembly film is less than an attraction force of the copper substrate to the liquid metal self-assembly film, and finally the liquid metal self-assembly film can be effectively transferred to the copper substrate as a pattern, achieving a patterned transfer.

It should be understood that the applications of the present disclosure are not limited to the above embodiments, and those skilled in the art can make improvements or transformations according to the above descriptions, and all these improvements and transformations should belong to the protection scope of the appended claims of the present disclosure.

1. A method for preparing a liquid metal self-assembly film, the method comprising steps of:
providing a surfactant solution and a liquid metal, wherein a solvent of the surfactant solution is an organic solvent, a density of the organic solvent is less than a density of water, the organic solvent is immiscible with water;
adding the liquid metal into a quantity of water to obtain a liquid metal solution;
adding the surfactant solution into the liquid metal solution for an ultrasonic mixing to obtain a liquid metal self-assembly seed solution;
mixing the liquid metal self-assembly seed solution and a quantity of water to obtain a mixture, wherein a lower layer of the mixture is a water phase, and an upper layer of the mixture is an oil phase; and obtaining the liquid metal self-assembly film at an oil-water interface.

2. The method according to claim 1, wherein the organic solvent is selected from the group consisting of methyl methacrylate, toluene, and n-hexane;
and/or, a surfactant in the surfactant solution is a surfactant containing a single carboxyl group, the surfactant containing the single carboxyl group is selected from the group consisting of acetic acid, propionic acid, butyric acid, valeric acid, hexanoic acid, heptanoic acid, octanoic acid, nonanoic acid, decanoic acids, hendecanoic acid, lauric acid, tridecanoic acid, myristic acid, isocetic acid, palmitic acid, margaric acid, stearic acid, nonadecanoic acid, arachidic acid, hexenoic acid, crotonic acid, pentenoic acid, hexenoic acid, heptenoic acid, octenoic acid, nonenoic acid, decenoic acid, undecenoic acid, dodecenoic acid, tridecenoic acid, tetradecenoic acid, pentadecenoic acid, hexadecenoic acid, heptadecenoic acid, octadecenoic acid, nonadecyenoic acid, and eicosenoic acid;
and/or, the liquid metal is selected from the group consisting of gallium indium tin alloy, and eutectic gallium indium.

3. The method according to claim 1, wherein a concentration of a surfactant in the surfactant solution is 0.5-9 mmol/L;
and/or, a concentration of the liquid metal in the liquid metal solution is 10-400 mg/mL.

4. The method according to claim 1, wherein a volume ratio of the surfactant solution to the liquid metal solution is (1-5):(9-5).

5. The method according to claim 1, wherein a duration of the ultrasonic mixing is 10-120 minutes, and a temperature of the ultrasonic mixing is 0-1° C.

6. The method according to claim 1, wherein in the step of mixing the liquid metal self-assembly seed solution and the quantity of water to obtain the mixture, a volume ratio of the liquid metal self-assembly seed solution to the quantity of water is 10:(20˜100).

7. The method according to claim 1, further comprising steps of:
providing a first substrate;
inserting the first substrate from the oil phase vertically into the water phase of the lower layer, tilting upwards and lifting one end of the first substrate inserted into the water phase until the end leaves an upper surface of the oil phase, transferring the liquid metal self-assembly film at the oil-water interface to the first substrate, and obtaining the liquid metal self-assembly film on the first substrate.

8. The method according to claim 1, wherein the method further comprises steps of:
providing a flexible second substrate having a preset pattern, inserting the flexible second substrate from the oil phase vertically into the water phase of the lower layer, tilting upwards and lifting one end of the flexible second substrate inserted into the water phase until the end leaves an upper surface of the oil phase, transferring the liquid metal self-assembly film at the oil-water interface to the flexible second substrate, forming a patterned liquid metal self-assembly film on the flexible second substrate, spraying ethanol on the patterned liquid metal self-assembly film;
providing a metal transfer substrate;
heating the metal transfer substrate, arranging the flexible second substrate containing the patterned liquid metal self-assembly film on the heated metal transfer substrate, wherein the patterned liquid metal self-assembly film is attached to the metal transfer substrate;
vertically pressing one side of the flexible second substrate deviating from the metal transfer substrate, transferring the patterned liquid metal self-assembly film onto the metal transfer substrate, and obtaining the patterned liquid metal self-assembly film on the metal transfer substrate.

9. A liquid metal self-assembly film, wherein the liquid metal self-assembly film is prepared by the method according to claim 1.

10. The liquid metal self-assembly film according to claim 9, wherein a thickness of the liquid metal self-assembly film is 300-1000 nm.
